(19) United States
(12) Patent Application Publication
(10) Pub. No.: US 2024/0152792 A1
(43) Pub. Date: May 9, 2024

(54) METHODS AND SYSTEMS FOR SOLVING AN INTEGER PROGRAMMING PROBLEM OR A MIXED-INTEGER PROGRAMMING PROBLEM USING A CIRCUIT-BASED CONTINUOUS-VARIABLE QUANTUM OPTICAL DEVICE

(71) Applicant: 1QB Information Technologies Inc., Vancouver (CA)

(72) Inventors: Farhad KHOSRAVI, Edmonton (CA); Pooya RONAGH, Guelph (CA); Artur SCHERER, Cochrane (CA)

(21) Appl. No.: 18/393,292

(22) Filed: Dec. 21, 2023

Related U.S. Application Data
(63) Continuation of application No. PCT/IB2022/056124, filed on Jun. 30, 2022.
(60) Provisional application No. 63/255,777, filed on Oct. 14, 2021.
(60) Provisional application No. 63/217,689, filed on Jul. 1, 2021.

(51) Int. Cl. G06N 10/40; G06F 17/11; G06N 10/60

(52) U.S. Cl. CPC G06N 10/40; G06F 17/11; G06N 10/60

(57) ABSTRACT

A method for solving an integer or a mixed-integer programming problem may include: (a) obtaining an indication of a quantum Hamiltonian representative of an integer or a mixed-integer programming problem; (b) implementing the quantum Hamiltonian on a quantum optical device, wherein the quantum optical device comprises quantum gates; (c) using the quantum optical device to prepare a quantum state of the system of qumodes; (d) performing a measurement of the system of the qumodes; and (e) providing a solution of the integer or the mixed-integer programming problem based on the measurement.

### CROSS-REFERENCE

This application is a continuation of International Application No. PCT/IB2022/056124, filed Jun. 30, 2022, which claims the benefit of U.S. Provisional Application No. 63/255,777, filed on Oct. 14, 2021 and the benefit of U.S. Provisional Application No. 63/217,689, filed on Jul. 1, 2021, each of which is incorporated by reference herein for all purposes.

### BACKGROUND

Integer programming and mixed-integer programming problems may be NP-complete. That is, the time used to solve a problem using a classical algorithm or computing platform can increase rapidly (e.g., exponentially) as the size of the problem grows. Integer programming problems may be of various types, such as integer linear programming or binary optimization. Integer programming and mixed-integer programming have many applications in various fields such as finance, industrial productions, territorial partitioning, and telecommunications networks. Integer and mixed-integer programming may be used to solve problems such as budget planning, maximum-clique problems, and scheduling.

### SUMMARY

Classical algorithms for solving mixed-integer programming problems may scale poorly with respect to problem size. Heuristic quantum algorithms may address the scaling problem. Although qubit-based quantum algorithms may scale polynomially with size, they may suffer from resource overhead due to the fact that the each of the integer and continuous variables of the problem may require being cast into multiple qubits as binary variables. By taking advantage of the internal functioning of a quantum optical device, our approach may be used to alleviate these problems by directly implementing the variables of the problem into the qumodes of the quantum optical device. Since photon numbers are fundamentally non-negative integers, the integer variables of the problem may be represented by the photon-number operators of the corresponding qumodes. Having only integer eigenvalues, the photon-number operators may represent integer variables of the problem without the need for ancilla qumodes. The fundamental feature of the quantum optical device that the photon-number states are discrete allows the representation of integer variables of a problem using the internal functioning of the quantum optical device. This approach may make efficient use of the resources available in a quantum optical device which may reduce the overhead. Combining this with the usual approach of representing continuous variables using quadrature operators, the quantum optical device may be capable of efficiently solving integer or mixed-integer programming problems. Improved methods of solving NP hard problems may generally improve the technical field of optimization. Further, improved implementations of hard computational problems on the architecture of the quantum optical device may improve the quantum optical device itself by expanding its capability to solve hard computational problems. Further, there is an extant need to solve NP hard problems which may be inefficiently solved on classical devices.

Recognized herein is the need for improved methods and systems that may improve a time used to solve an integer or a mixed-integer programing problem. Methods and systems disclosed herein may improve upon methods and systems employing a classical algorithm or computing platform.

The present disclosure provides methods and systems for solving an integer programming problem or a mixed-integer programming problem. The present disclosure may improve upon existing optimization solvers in at least some aspects by using non-classical devices, e.g., quantum devices and quantum optical devices. In particular, directly implementing the variables of the problem (e.g., the variables of the optimization problem to be optimized) into the qumodes of the quantum optical device may leverage inherent capabilities of a quantum optical device to solve problems that are inefficiently solved on classical computers.

In an aspect, the present disclosure provides a method for solving an integer programming problem or a mixed-integer programming problem using a quantum optical device. The method may comprise (a) obtaining an indication of a quantum Hamiltonian representative of said integer programming problem or said mixed-integer programming problem, wherein said quantum Hamiltonian comprises a class of operators corresponding to variables of said integer programming problem or said mixed-integer programming problem; (b) implementing said quantum Hamiltonian on said quantum optical device, wherein said quantum optical device comprises a system of qumodes and at least one quantum gate configured to act on one or more qumodes in said system of qumodes, and wherein one or more operators in said class of operators corresponds to said one or more qumodes in said system of qumodes; and (c) providing a solution of said integer programming problem or said mixed-integer programming problem based at least in part on a measurement of said system of qumodes.

In some embodiments, said class of operators comprises photon-number operators of said quantum Hamiltonian. In some embodiments, integer variables of said integer programming problem or said mixed-integer programming problem correspond to said photon-number operators of said quantum Hamiltonian. In some embodiments, said class of operators comprises momentum and position operators of said quantum Hamiltonian. In some embodiments, said quantum Hamiltonian is representative of said mixed-integer programming problem, and continuous variables of said mixed-integer programming problem correspond to said momentum and position operators of said quantum Hamiltonian.

In some embodiments, said quantum state of said system of qumodes overlaps with a ground state of said quantum Hamiltonian. In some embodiments, said measurement comprises a measurement corresponding to said photon-number operators to obtain photon-number values. In some embodiments, said measurement comprises a homodyne measurement corresponding to said position and momentum operators to obtain position and momentum values. In some embodiments, said homodyne measurement comprises a homodyne detection using a beam splitter and two photo-detectors for measuring two out-of-phase components of the optical electric field.

In some embodiments, (b) further comprises: (i) using said quantum optical device to prepare a quantum state of said system of qumodes. In some embodiments, the method further comprises simulating a Hamiltonian of a quantum adiabatic evolution. In some embodiments, (i) comprises an approximation of a quantum adiabatic evolution from a ground state of a mixing Hamiltonian to said quantum state of said system of qumodes. In some embodiments, said mixing Hamiltonian comprises operators which do not commute with photon-number operators. In some embodiments, said mixing Hamiltonian comprises position or momentum operators as non-commuting operators with photon-number operators. In some embodiments, said approximation of said quantum adiabatic evolution comprises a discretized quantum adiabatic algorithm (dQAA) procedure. In some embodiments, said approximation of said quantum adiabatic evolution comprises a quantum approximate optimization algorithm (QAOA) procedure. In some embodiments, (i) comprises performing one or more gate operations.

In some embodiments, (c) comprises: (ii) performing said measurement of said system of qumodes. In some embodiments, said measurement in (ii) comprises a photon-number-resolving measurement of said one or more qumodes. In some embodiments, (b) comprises configuring said quantum optical device, wherein said configuring comprises setting one or more of: a rotation gate, a Kerr gate, a cross-Kerr gate, a P-gate, a quadratic phase gate, a displacement gate, a displacement momentum gate, a displacement position gate, a Fourier gate, a beam splitter, a squeezing gate, a controlled addition gate, a controlled phase gate, a two-mode squeezing gate, a position-rotation gate, a quadratic position-rotation gate, a cross-position-rotation gate, a momentum-rotation gate, a quadratic momentum-rotation gate, or a cross-momentum-rotation gate.

In some embodiments, said at least one quantum gate is implemented using at least one of Kerr nonlinearity, quantum dots, Rydberg blockades, or four-wave mixing atomic systems. In some embodiments, said quantum Hamiltonian is quadratic in photon-number operators. In some embodiments, said quantum Hamiltonian is quartic in momentum and position operators.

In some embodiments, (b) comprises (i) using said quantum optical device to prepare a quantum state of said system of qumodes and (c) comprises (ii) performing a measurement of said system of qumodes, wherein (i), (ii), and (c) are repeated one or more times. In some embodiments, (i), (ii), and (c) are repeated one or more times until a convergence condition is met, and, optionally, said convergence condition comprises a threshold number of iterations or a threshold change in an objective function. In some embodiments, said indication of the quantum Hamiltonian is obtained from a user. In some embodiments, said indication of the quantum Hamiltonian is obtained from a computer-implemented method for solving said integer programming problem or said mixed-integer programming problem.

In another aspect, the present disclosure provides a method for solving an integer programming problem or a mixed-integer programming problem using a quantum optical device. The method may comprise at a digital computer operably connected to said quantum optical device: (a) obtaining an indication of a quantum Hamiltonian representative of said integer programming problem or said mixed-integer programming problem, wherein said quantum Hamiltonian comprises a class of operators corresponding to variables of said integer programming problem or said mixed-integer programming problem; (b) directing said quantum Hamiltonian to said quantum optical device, wherein said quantum optical device implements said quantum Hamiltonian, wherein said quantum optical device comprises a system of qumodes and at least one quantum gate configured to act on one or more qumodes in said system of qumodes, and wherein one or more operators in said class of operators corresponds to said one or more qumodes in said system of qumodes; and (c) providing a solution of said integer programming problem or said mixed-integer programming problem based at least in part on a measurement of said system of qumodes on said quantum optical device.

In some embodiments, said class of operators comprises photon-number operators of said quantum Hamiltonian. In some embodiments, integer variables of said integer programming problem or said mixed-integer programming problem correspond to said photon-number operators of said quantum Hamiltonian. In some embodiments, said class of operators comprises momentum and position operators of said quantum Hamiltonian. In some embodiments, said quantum Hamiltonian is representative of said mixed-integer programming problem, and continuous variables of said mixed-integer programming problem correspond to said momentum and position operators of said quantum Hamiltonian.

In some embodiments, said quantum state of said system of qumodes overlaps with a ground state of said quantum Hamiltonian. In some embodiments, said measurement comprises a measurement corresponding to said photon-number operators to obtain photon-number values. In some embodiments, said measurement comprises a homodyne measurement corresponding to said position and momentum operators to obtain position and momentum values. In some embodiments, said homodyne measurement comprises a homodyne detection using a beam splitter and two photo-detectors for measuring two out-of-phase components of the optical electric field.

In some embodiments, (b) further comprises: (i) using said quantum optical device to prepare a quantum state of said system of qumodes. In some embodiments, the method further comprises simulating a Hamiltonian of a quantum adiabatic evolution. In some embodiments, (i) comprises an approximation of a quantum adiabatic evolution from a ground state of a mixing Hamiltonian to said quantum state of said system of qumodes. In some embodiments, said mixing Hamiltonian comprises operators which do not commute with photon-number operators. In some embodiments, said mixing Hamiltonian comprises position or momentum operators as non-commuting operators with photon-number operators. In some embodiments, said approximation of said quantum adiabatic evolution comprises a discretized quantum adiabatic algorithm (dQAA) procedure. In some embodiments, said approximation of said quantum adiabatic evolution comprises a quantum approximate optimization algorithm (QAOA) procedure. In some embodiments, (i) comprises performing one or more gate operations.

In some embodiments, (c) comprises: (ii) performing said measurement of said system of qumodes. In some embodiments, said measurement in (ii) comprises a photon-number-resolving measurement of said one or more qumodes. In some embodiments, (b) comprises configuring said quantum optical device, wherein said configuring comprises setting one or more of: a rotation gate, a Kerr gate, a cross-Kerr gate, a P-gate, a quadratic phase gate, a displacement gate, a displacement momentum gate, a displacement position gate, a Fourier gate, a beam splitter, a squeezing gate, a controlled addition gate, a controlled phase gate, a two-mode squeezing gate, a position-rotation gate, a quadratic position-rotation gate, a cross-position-rotation gate, a momentum-rotation gate, a quadratic momentum-rotation gate, or a cross-momentum-rotation gate.

In some embodiments, said at least one quantum gate is implemented using at least one of Kerr nonlinearity, quantum dots, Rydberg blockades, or four-wave mixing atomic systems. In some embodiments, said quantum Hamiltonian is quadratic in photon-number operators. In some embodiments, said quantum Hamiltonian is quartic in momentum and position operators.

In some embodiments, (b) comprises (i) using said quantum optical device to prepare a quantum state of said system of qumodes and (c) comprises (ii) performing a measurement of said system of qumodes, wherein (i), (ii), and (c) are repeated one or more times. In some embodiments, (i), (ii), and (c) are repeated one or more times until a convergence condition is met, and, optionally, said convergence condition comprises a threshold number of iterations or a threshold change in an objective function. In some embodiments, said indication of the quantum Hamiltonian is obtained from a user. In some embodiments, said indication of the quantum Hamiltonian is obtained from a computer-implemented method for solving said integer programming problem or said mixed-integer programming problem.

In another aspect, the present disclosure provides a quantum optical device comprising a system of qumodes and at least one quantum gate configured to act on one or more qumodes of said system of qumodes, wherein said at least one quantum gate comprises at least one member of the group including a position-rotation gate, a quadratic position-rotation gate, a cross-position-rotation gate, a momentum-rotation gate, a quadratic momentum-rotation gate, and a cross-momentum-rotation gate.

In another aspect, the present disclosure provides a system for solving an integer programming problem or a mixed-integer programming problem using a quantum optical device. The system may comprise: (a) a quantum optical device comprising a control system, a system of qumodes, and at least one quantum gate configured to act on one or more qumodes of said system of qumodes, wherein said quantum optical device is configured to at least (i) implement a quantum Hamiltonian; (ii) prepare a quantum state of said system of qumodes; and (iii) perform measurements of said system of qumodes; (b) a classical computer operatively connected to said quantum optical device, a digital computer comprising a memory comprising instructions, wherein said digital computer is configured to execute said instructions to at least: (i) obtain an indication of a quantum Hamiltonian representative of an integer programming problem or a mixed-integer programming problem; (ii) provide said instructions to said quantum optical device; and (iii) receive results from said quantum optical device.

In some embodiments, said quantum Hamiltonian comprises a class of operators corresponding to variables of said integer programming problem or said mixed-integer programming problem, and one or more operators in said class of operators corresponds to said one or more qumodes in said system of qumodes. In some embodiments, said class of operators comprises photon-number operators of said quantum Hamiltonian. In some embodiments, integer variables of said integer programming problem or said mixed-integer programming problem correspond to said photon-number operators of said quantum Hamiltonian. In some embodiments, said class of operators comprises momentum and position operators of said quantum Hamiltonian. In some embodiments, said quantum Hamiltonian is representative of said mixed-integer programming problem, and continuous variables of said mixed-integer programming problem correspond to said momentum and position operators of said quantum Hamiltonian. In some embodiments, said quantum state of said system of qumodes overlaps with a ground state of said quantum Hamiltonian. In some embodiments, said measurement comprises a measurement corresponding to said photon-number operators to obtain photon-number values. In some embodiments ,said measurement comprises a homodyne measurement corresponding to said position and momentum operators to obtain position and momentum values. In some embodiments, said homodyne measurement comprises a homodyne detection using a beam splitter and two photo-detectors for measuring two out-of-phase components of the optical electric field.

In some embodiments, said quantum optical device is configured to at least simulate a Hamiltonian of a quantum adiabatic evolution. In some embodiments, (a)(ii) comprises an approximation of a quantum adiabatic evolution from a ground state of a mixing Hamiltonian to said quantum state of said system of qumodes. In some embodiments, said mixing Hamiltonian comprises operators which do not commute with photon-number operators. In some embodiments, said mixing Hamiltonian comprises position or momentum operators as non-commuting operators with photon-number operators. In some embodiments, said approximation of said quantum adiabatic evolution comprises a discretized quantum adiabatic algorithm (dQAA) procedure. In some embodiments, said approximation of said quantum adiabatic evolution comprises a quantum approximate optimization algorithm (QAOA) procedure. In some embodiments, (a)(ii) comprises one or more gate operations. In some embodiments, said measurements in (a)(iii) comprises a photon-number-resolving measurement of said one or more qumodes. In some embodiments, (b)(ii) comprises configuring said quantum optical device, wherein said configuring comprises setting one or more of: a rotation gate, a Kerr gate, a cross-Kerr gate, a P-gate, a quadratic phase gate, a displacement gate, a displacement momentum gate, a displacement position gate, a Fourier gate, a beam splitter, a squeezing gate, a controlled addition gate, a controlled phase gate, a two-mode squeezing gate, a position-rotation gate, a quadratic position-rotation gate, a cross-position-rotation gate, a momentum-rotation gate, a quadratic momentum-rotation gate, or a cross-momentum-rotation gate.

In some embodiments, said at least one quantum gate is implemented using at least one of Kerr nonlinearity, quantum dots, Rydberg blockades, or four-wave mixing atomic systems. In some embodiments, said quantum Hamiltonian is quadratic in photon-number operators. In some embodiments, said quantum Hamiltonian is quartic in momentum and position operators. In some embodiments, (a) is repeated one or more times. In some embodiments, (a) is repeated one or more times until a convergence condition is met, and, optionally, said convergence condition comprises a threshold number of iterations or a threshold change in an objective function. In some embodiments, said indication of the quantum Hamiltonian is obtained from a user. In some embodiments, said indication of the quantum Hamiltonian is obtained from a computer-implemented method for solving said integer programming problem or said mixed-integer programming problem.

In another aspect, the present disclosure provides s system for solving an integer programming problem or a mixed-integer programming problem using a quantum optical device. The system may comprise: a quantum optical device comprising: a system of qumodes; and at least one quantum gate configured to act on one or more qumodes of said system of qumodes, wherein said quantum optical device is configured to implement a quantum Hamiltonian, wherein said quantum Hamiltonian is representative of an integer programming problem or a mixed-integer programming problem, wherein said quantum Hamiltonian comprises a class of operators corresponding to variables of said integer programming problem or said mixed-integer programming problem, and wherein one or more operators in said class of operators corresponds to said one or more qumodes in said system of qumodes.

In some embodiments, said quantum optical device further comprises a control system, wherein the control system is configured to receive instructions from a digital computer operably coupled to said quantum optical device. In some embodiments, said digital computer comprises a memory comprising instructions, wherein said digital computer is configured to execute said instructions to at least: (i) obtain an indication of said quantum Hamiltonian representative of said integer programming problem or said mixed-integer programming problem; (ii) implement said quantum Hamiltonian on said quantum optical device; and (iii) receive results from said quantum optical device, wherein said results are based at least in part on a measurement of said system of qumodes on said quantum optical device.

In some embodiments, said class of operators comprises photon-number operators of said quantum Hamiltonian. In some embodiments, integer variables of said integer programming problem or said mixed-integer programming problem correspond to said photon-number operators of said quantum Hamiltonian. In some embodiments, said class of operators comprises momentum and position operators of said quantum Hamiltonian. In some embodiments, said quantum Hamiltonian is representative of said mixed-integer programming problem, and continuous variables of said mixed-integer programming problem correspond to said momentum and position operators of said quantum Hamiltonian. In some embodiments, said quantum state of said system of qumodes overlaps with a ground state of said quantum Hamiltonian.

In some embodiments, said measurement comprises a measurement corresponding to said photon-number operators to obtain photon-number values. In some embodiments, said measurement comprises a homodyne measurement corresponding to said position and momentum operators to obtain position and momentum values. In some embodiments, said homodyne measurement comprises a homodyne detection using a beam splitter and two photo-detectors for measuring two out-of-phase components of the optical electric field.

In some embodiments, said quantum optical device is configured to prepare a quantum state of said system of qumodes. In some embodiments, said quantum optical device is configured to simulate a Hamiltonian of a quantum adiabatic evolution. In some embodiments, said quantum optical device is configured to implement an approximation of a quantum adiabatic evolution from a ground state of a mixing Hamiltonian to said quantum state of said system of qumodes. In some embodiments, said mixing Hamiltonian comprises operators which do not commute with photon-number operators. In some embodiments, said mixing Hamiltonian comprises position or momentum operators as non-commuting operators with photon-number operators. In some embodiments, said approximation of said quantum adiabatic evolution comprises a discretized quantum adiabatic algorithm (dQAA) procedure. In some embodiments, said approximation of said quantum adiabatic evolution comprises a quantum approximate optimization algorithm (QAOA) procedure.

In some embodiments, said quantum optical device is configured to perform one or more gate operations. In some embodiments, said quantum optical device is configured to perform said measurement of said system of qumodes. In some embodiments, said measurement comprises a photon-number-resolving measurement of said one or more qumodes.

In some embodiments, said control system is configured to configure said quantum optical device, wherein said configuring comprises setting one or more of: a rotation gate, a Kerr gate, a cross-Kerr gate, a P-gate, a quadratic phase gate, a displacement gate, a displacement momentum gate, a displacement position gate, a Fourier gate, a beam splitter, a squeezing gate, a controlled addition gate, a controlled phase gate, a two-mode squeezing gate, a position-rotation gate, a quadratic position-rotation gate, a cross-position-rotation gate, a momentum-rotation gate, a quadratic momentum-rotation gate, or a cross-momentum-rotation gate.

In some embodiments, said at least one quantum gate is implemented using at least one of Kerr nonlinearity, quantum dots, Rydberg blockades, or four-wave mixing atomic systems. In some embodiments, said quantum Hamiltonian is quadratic in photon-number operators. In some embodiments, said quantum Hamiltonian is quartic in momentum and position operators.

In some embodiments, said quantum optical device is configured to: (i) prepare a quantum state of said system of qumodes, and (ii) perform a measurement of said system of qumodes; and said digital computer is configured to: (iii) provide said solution of said integer programming problem or said mixed-integer programming problem based at least in part on said measurement of said system of qumodes, and (i), (ii), and (iii) are repeated one or more times. In some embodiments, (i), (ii), and (iii) are repeated one or more times until a convergence condition is met, and, optionally, said convergence condition comprises a threshold number of iterations or a threshold change in an objective function. In some embodiments, said indication of the quantum Hamiltonian is obtained from a user. In some embodiments, said indication of the quantum Hamiltonian is obtained from a computer-implemented method for solving said integer programming problem or said mixed-integer programming problem.

In another aspect, the present disclosure provides a system for solving an integer programming problem or a mixed-integer programming problem using a quantum optical device. The system may comprise: a digital computer operatively connected to said quantum optical device, said digital computer comprising a memory comprising instructions, wherein said digital computer is configured to execute said instructions to at least: (i) obtain an indication of a quantum Hamiltonian representative of an integer programming problem or a mixed-integer programming problem; (ii) direct said quantum Hamiltonian to a quantum optical device, wherein said quantum optical device implements said quantum Hamiltonian, wherein said quantum optical device comprises a system of qumodes and at least one quantum gate configured to act on one or more qumodes in said system of qumodes, and wherein one or more operators in said class of operators corresponds to said one or more qumodes in said system of qumodes; and (iii) receive results from said quantum optical device, wherein said results are based at least in part on a measurement of said system of qumodes on said quantum optical device.

In some embodiments, the system further comprises a quantum optical device comprising: a system of qumodes; and at least one quantum gate configured to act on one or more qumodes of said system of qumodes. In some embodiments, said quantum optical device further comprises a control system, wherein the control system is configured to receive said instructions from said digital computer operably coupled to said quantum optical device. In some embodiments, said class of operators comprises photon-number operators of said quantum Hamiltonian. In some embodiments, integer variables of said integer programming problem or said mixed-integer programming problem correspond to said photon-number operators of said quantum Hamiltonian. In some embodiments, said class of operators comprises momentum and position operators of said quantum Hamiltonian. In some embodiments, said quantum Hamiltonian is representative of said mixed-integer programming problem, and continuous variables of said mixed-integer programming problem correspond to said momentum and position operators of said quantum Hamiltonian.

In some embodiments, said quantum state of said system of qumodes overlaps with a ground state of said quantum Hamiltonian. In some embodiments, said measurement comprises a measurement corresponding to said photon-number operators to obtain photon-number values. In some embodiments, said measurement comprises a homodyne measurement corresponding to said position and momentum operators to obtain position and momentum values. In some embodiments, said homodyne measurement comprises a homodyne detection using a beam splitter and two photo-detectors for measuring two out-of-phase components of the optical electric field.

In some embodiments, said quantum optical device prepares a quantum state of said system of qumodes. In some embodiments, said quantum optical device simulates a Hamiltonian of a quantum adiabatic evolution. In some embodiments, said quantum optical device implements an approximation of a quantum adiabatic evolution from a ground state of a mixing Hamiltonian to said quantum state of said system of qumodes. In some embodiments, said mixing Hamiltonian comprises operators which do not commute with photon-number operators. In some embodiments, said mixing Hamiltonian comprises position or momentum operators as non-commuting operators with photon-number operators. In some embodiments, said approximation of said quantum adiabatic evolution comprises a discretized quantum adiabatic algorithm (dQAA) procedure. In some embodiments, said approximation of said quantum adiabatic evolution comprises a quantum approximate optimization algorithm (QAOA) procedure.

In some embodiments, said quantum optical device performs one or more gate operations. In some embodiments, said quantum optical device performs said measurement of said system of qumodes. In some embodiments, said measurement comprises a photon-number-resolving measurement of said one or more qumodes. In some embodiments, said digital computer is configured direct a control system to configure said quantum optical device, said configuring comprises setting one or more of: a rotation gate, a Kerr gate, a cross-Kerr gate, a P-gate, a quadratic phase gate, a displacement gate, a displacement momentum gate, a displacement position gate, a Fourier gate, a beam splitter, a squeezing gate, a controlled addition gate, a controlled phase gate, a two-mode squeezing gate, a position-rotation gate, a quadratic position-rotation gate, a cross-position-rotation gate, a momentum-rotation gate, a quadratic momentum-rotation gate, or a cross-momentum-rotation gate.

In some embodiments, said at least one quantum gate is implemented using at least one of Kerr nonlinearity, quantum dots, Rydberg blockades, or four-wave mixing atomic systems. In some embodiments, said quantum Hamiltonian is quadratic in photon-number operators. In some embodiments, said quantum Hamiltonian is quartic in momentum and position operators. In some embodiments, said quantum optical device is configured to: (i) prepare a quantum state of said system of qumodes, and (ii) perform a measurement of said system of qumodes; and said digital computer is configured to: (iii) provide said solution of said integer programming problem or said mixed-integer programming problem based at least in part on said measurement of said system of qumodes. In some embodiments, (i), (ii), and (iii) are repeated one or more times. In some embodiments, (i), (ii), and (iii) are repeated one or more times until a convergence condition is met, and, optionally, said convergence condition comprises a threshold number of iterations or a threshold change in an objective function. In some embodiments, said indication of the quantum Hamiltonian is obtained from a user. In some embodiments, said indication of the quantum Hamiltonian is obtained from a computer-implemented method for solving said integer programming problem or said mixed-integer programming problem.

Another aspect of the present disclosure provides a system comprising one or more computer processors and a computer memory coupled thereto. The computer memory comprises machine executable code that, upon execution by the one or more computer processors, implements any of the methods disclosed elsewhere herein.

Additional aspects and advantages of the present disclosure will become readily apparent to those skilled in the art from the following detailed description, wherein only illustrative embodiments of the present disclosure are shown and described. As will be realized, the present disclosure is capable of being realized in other and different embodiments, and its several details may be modified in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention may be obtained by reference to the following detailed description that sets forth illustrative embodiments, in which the principles of the invention are utilized, and the accompanying drawings (also “Figure” and “FIG.” herein), of which:

FIG. 1 is a schematic of an example of a system for solving an integer programming problem or a mixed-integer programming problem using a quantum optical device, in accordance with some embodiments disclosed herein.

FIG. 2 is a flowchart of an example of a method for solving an integer programming problem using a quantum optical device, in accordance with some embodiments disclosed herein.

FIG. 3 is a flowchart of an example of a method for solving a mixed-integer programming problem using a quantum optical device, in accordance with some embodiments disclosed herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

The term “plurality” generally refers to “two or more,” unless expressly specified otherwise.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every subrange and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value.

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be used, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A “qubit,” short for “quantum bit,” generally refers to the basic unit of quantum information.

As used herein, the term “quantum gate” generally refers to one of a sequence of operations in a gate model quantum computer. The term “quantum gate” may also refer to logical operators comprising one or multiple qubits, which can be used to perform logical operations. A quantum gate may be a physical device that transforms a quantum state of its input according to a unitary transformation that describes the particular action of the quantum gate.

As used herein, the term “quantum computing” generally refers to the method of computing which utilizes the concept of quantum superposition and entanglement to manipulate information, instead of the 0 and 1 binary bits in classical computers. Quantum entanglement generally refers to the phenomenon in which when multiple qubits interact with each other, their quantum states will be “entangled” and may no longer be represented individually. Quantum superposition generally refers to the principle which states that the quantum state of a qubit can be represented by adding together two or more different quantum states, each associated with a probability. In some cases, the probabilities of all states add to 1. Quantum circuits, consisting of one or more quantum gates, may be designed to perform quantum computation, such as factoring large prime numbers, which may be infeasible or highly inefficient for classical computers.

As used herein, the term “classical,” as used in the context of computing or computation, generally refers to computation performed using binary values using discrete bits without use of quantum mechanical superposition and quantum mechanical entanglement. A classical computer may be a digital computer, such as a computer employing discrete bits (e.g., 0s and 1s) without use of quantum mechanical superposition and quantum mechanical entanglement.

As used herein, the term “non-classical,” as used in the context of computing or computation, generally refers to any method or system for performing computational procedures outside of the paradigm of classical computing.

As used herein, the term “qumode” generally refers to a quantum state represented as a quantum mode. A quantum mode may be an optical mode expressed as a superposition of a set of possible quantum photon number states. The optical mode may be a single optical mode of a quantum optical device as described herein. The superposition may be an infinite superposition of all possible quantum photon number states. A qumode may be an alternative to representing quantum information in terms of qubits or qudits. A qubit may be a discrete packet of information representing a superposition of the binary values, e.g., zero and one.

As used herein, the term “quantum optical device” generally refers to a non-classical computer which is an optical computing device. An optical computing device may use light for data processing, data storage, or data communication. For example, in an optical computing device photons may be used as information carriers. A quantum optical device may be an apparatus comprising optical elements which may act as quantum gates on photons. In some cases, optical elements may maintain the quantum coherence between different quantum states. In some cases, the inputs and outputs of a quantum optical device are qumodes. In some cases, a quantum optical device is an optical quantum computer, such as, for example, a linear optical quantum computer or a non-linear optical quantum computer.

As used herein, the term “integer programming problem” generally refers to a mathematical problem where the variables' values are integers. An integer programming problem may comprise variables that are constrained to being integers.

As used herein, the term “mixed-integer programming problem” generally refers to a mathematical problem where at least one variable is an integer and the rest of the variables may take continuous values. A mixed-integer programming problem may comprise at least one variable that is constrained to being an integer.

An optimization problem may be the problem of finding an improved solution from a set of feasible solutions. In some cases, the improved solution may be a “best” or “optimum” solution, such as a minimum or a maximum. The problem of finding an improved solution may comprise minimizing or maximizing an objective function that is a function of a set of variables. A minimum may be a local minimum or a global minimum. A maximum may be a local maximum or a global maximum. However, in many cases, a solution that reasonably approximates a “best” or an “optimum” solution may be a sufficient solution. In some cases, what constitutes a reasonable approximation may be subject to a condition set by a user. For example, an optimization problem may be solved subject to a condition which may set a limit at which a solution is sufficient or a reasonable approximation of an “optimum” solution. In some cases, an optimization problem may employ a heuristic. A solution to a heuristic may not be a “best” of all possible solution but a reasonable approximation. Heuristics may be used alone or in combination with formally “exact” optimization algorithms.

As used herein, the term “integer optimization problem” generally refers to a class of integer programming problems where the mathematical problem is an optimization problem. Integer and mixed-integer programming problems may be represented by an objective function that is a function of integer or continuous variables or both. In some cases, the point at which the objective function is minimized refers to the solution of the problem.

As used herein, the term “mixed-integer optimization problem” generally refers to a class of mixed-integer programming problems where the mathematical problem is an optimization problem.

There exist various algorithms and methods for solving integer or mixed-integer programming problems. Systems and methods for solving integer or mixed-integer programming problems may be exact. Systems and methods for solving integer or mixed-integer programming problems may comprise various heuristics which may not be exact. Even some medium-sized instances may be intractable for exact solvers. While some heuristic methods may be efficient for solving some optimization problems, they may have limited application because they may exploit specific structures of the problem class being solved. More details can be found in “Integer programming” by Conforti et al., vol. 271, Berlin: Springer, 2014; in “Integer programming with a fixed number of variables” by Lenstra Jr. et al., Mathematics of operations research 8, no. 4: pp. 538-548, 1983; or in “Tabu search—part II” by Glover, ORSA Journal on computing 2, no. 1: pp. 4-32, 1990, each of which is incorporated by reference herein for all purposes.

As used herein, the term “photon-number operators” generally refer to quantum operators acting on optical quantum states whose eigenstates may be the photon-number quantum states and whose eigenvalues may give the number of photons in a given quantum number state.

Neither the Title nor the Abstract is to be taken as limiting in any way the scope of the disclosed invention(s). The title of the present application and headings of sections provided in the present application are for convenience only and are not to be taken as limiting the disclosure in any way.

An advantage of some examples of the methods and systems disclosed herein is that the solutions provided by the quantum optical device are integers, since photon numbers are integers. This may remove the need for rounding the solutions to the nearest integer, which can introduce additional errors and inaccuracies.

Another advantage of some examples of the methods and systems disclosed herein is the capability of the quantum optical device to find solutions to the quantum computation methods heuristically in polynomial time. For many of the problems studied, the number of gate operations may scale polynomially with the problem size. Polynomial scaling may be an advantage over other methods in that integer programming problems are generally NP-complete and scale exponentially.

Another advantage of some examples of the methods and systems disclosed herein is that the solutions provided by the quantum optical device may include both integers and continuous numbers. This may allow for solving mixed-integer programming problems without the need for rounding or approximations.

The methods and systems disclosed herein take advantage of the internal functioning of the quantum optical device to solve integer or mixed-integer programming problems. This internal functioning refers to the quantum optical device being fundamentally a bosonic system that is represented by an infinite-dimensional Hilbert space that has photon-number states as the basis. Being a bosonic system, the photons in the quantum optical device follow Bose-Einstein statistics, meaning that multiple photons may be present simultaneously in the same quantum state. The bosonic nature of the quantum optical device, as described elsewhere herein, may be expressed by writing the quantum states as the superposition of all possible photon-number states, up to infinity. Since photon numbers are fundamentally non-negative integers, the integer variables of the problem may be represented by the photon-number operators of the corresponding qumodes. Having only integer eigenvalues, the photon-number operators may represent integer variables of the problem without the need for ancilla qumodes. The fundamental feature of the quantum optical device that the photon-number states are discrete allows the representation of integer variables of a problem using the internal functioning of the quantum optical device. This approach may make efficient use of the resources available in a quantum optical device which may reduce the overhead. Combining this with the usual approach of representing continuous variables using quadrature operators, the quantum optical device may be capable of efficiently solving integer or mixed-integer programming problems.

Discretized Quantum Adiabatic Algorithm (dQAA) and Quantum Approximate Optimization Algorithm (QAOA)

The ground states of a quantum Hamiltonian (which is treated as the target Hamiltonian) may be found using the discretized quantum adiabatic algorithm (dQAA) or the quantum approximate optimization algorithm (QAOA). These algorithms are approximate methods of quantum adiabatic (QA) evolution, where the Hamiltonian of the system may be adiabatically evolved from a mixing Hamiltonian to a target Hamiltonian, the latter of which may represent the integer programming problem or the mixed-integer programming problem.

The discretized quantum adiabatic algorithm may be a version of quantum adiabatic evolution discretized in time. The change of the system Hamiltonian may occur in steps during which the Hamiltonian may remain constant. The time evolution of the system Hamiltonian may approach that of actual quantum adiabatic evolution when increasing the number of steps.

According to the quantum adiabatic theorem, by initializing the system in a ground state of the mixing Hamiltonian, and evolving it according to the QA method, a ground state of the target Hamiltonian may be reached with high probability. In practice, a quantum state that overlaps with at least one of the ground states of the target Hamiltonian may be reached using quantum adiabatic evolution. In some examples, the extent of overlap may be at least 80% or 90%. In some cases, the overlap may involve two or more ground states. In some cases, the overlap may involve three or more ground states. The existence of an overlap means that although the quantum state of the target Hamiltonian may be a superposition of multiple eigenstates, it may have a large amplitude for at least one of the ground states of the target Hamiltonian. By performing a Trotterization of the quantum adiabatic evolution (i.e., evolving the quantum states, alternating between using the mixing Hamiltonian and target Hamiltonian, with evolution durations determined according to some scheduling), the discretized quantum adiabatic algorithm (dQAA) may be obtained. The performance of the discretized quantum adiabatic algorithm (dQAA) may reach the performance of the QA method in the limit of infinite discretization. If the number of discretizations is small (e.g., only a few discretizations are performed), and a classical algorithm is used to optimize the scheduling of the evolution durations of the mixing and target Hamiltonians, then the quantum approximate optimization algorithm (QAOA) may be obtained. The discretized quantum adiabatic algorithm (dQAA) and the quantum approximate optimization algorithm (QAOA) may be implemented on circuit-model quantum devices. Alternatively, the QA method may be approximated by Hamiltonian simulation techniques, such as Taylor series expansion or qubitization methods (see, for example, “Simulating Hamiltonian dynamics with a truncated Taylor series” by Berry et al., Physical Review Letters 114, no. 9: 090502, 2015 and “Hamiltonian simulation by qubitization” by Low et al., Quantum 3: 163, 2019, each of which is incorporated by reference herein for all purposes.

### Quantum Optical Device

The computational task discussed herein may be performed by a quantum optical device. This device may prepare initial optical quantum states known as qumodes and perform a series of quantum gates on these optical quantum states. These gates may use quantum optical elements that may perform appropriate quantum unitary transformations. The quantum optical device may further perform quantum measurements, such as photon-number-resolving measurements and homodyne detections, on the qumodes to determine the final quantum states. This determination may be performed by statistically finding the probability distributions of the final quantum states in the quantum number basis, which may be determined through repeated measurements. More details can be found in US 2019/0325589 and in “Applications of near-term photonic quantum computers: software and algorithms” by Bromley et al., Quantum Science and Technology 5, no. 3: 034010, 2020, each of which is incorporated by reference herein for all purposes. In the company Xanadu's quantum optical device, for instance, the initial states may be squeezed vacuum states prepared by squeezing the on-chip vacuum states using an optical crystal with high second-order nonlinearity. An example of such crystals may be lithium niobates, which have been used in quantum optical devices. These squeezed vacuum states may then traverse quantum optical gates which may perform the predetermined operations. Phase shifters, for instance, may be implemented using materials with temperature-dependent refractive indices, which may be manipulated using voltage-controlled heating plates. In some examples, quantum optical gates may be used, such as on-chip and fiber optical directional couplers or beam splitters, which may create quantum superposition between qumodes. In some examples, the superposition may be between two or more qumodes.

Measurements performed on qumodes may comprise quantum photon-number-resolving measurements and homodyne measurements. By measuring the intensity of the optical field, and comparing its phase to a reference phase, the results of the homodyne measurements can be used to infer the results of performing quantum measurements in the position or momentum basis. While homodyne measurements are continuous measurements that may be performed with high precision, quantum photon-number-resolving measurements may be more technologically demanding to perform due to difficulties in detecting single photons. Examples of photon-number detectors may include but are not limited to single-photon avalanche detectors (SPAD) that can detect whether the photon number is zero or nonzero, and photon-number-resolving detectors (PNRD), which can report the number of photons detected up to about a few photons. In some examples, a PNRD may output at least two, at least three, at least four, at least five, at least six, at least seven, at least eight, at least nine, or at least ten photons. The control voltage signals for the squeezers and the quantum gates, as well as the outcomes of the quantum measurements, may be controlled and collected by a classical computing device, such as a field-programmable gate array (FPGA), and may be converted between values meaningful in terms of the mathematical description of the computational task to voltages appropriate for the optical gates and detectors.

### Classical Computer

In some cases, the systems, media, networks, and methods described herein comprise a classical computer, or use of the same. In some cases, a classical computer may comprise a digital computer. In some cases, the classical computer includes one or more hardware central processing units (CPUs, also “processors” and “computer processors” herein) that carry out the classical computer's functions. This may be a single core or multi-core processor, or a plurality of processors for parallel processing. In some cases, the classical computer further comprises an operating system (OS) configured to perform executable instructions. The instructions can be directed to the CPUs, which can subsequently program or otherwise configure the CPUs to implement methods of the present disclosure. Examples of operations performed by the CPUs include fetch, decode, execute, and writeback.

In some cases, the classical computer is connected to a computer network. In some cases, the classical computer is connected to the Internet such that it accesses the World Wide Web. In some cases, the classical computer is connected to one or more computer servers, which can enable distributed computing, such as a cloud computing infrastructure. In some cases, the classical computer is connected to an intranet and/or extranet or an intranet and/or extranet that is in communication with the Internet. In some cases, the classical computer is connected to a data storage device. In some cases, the network is a telecommunication and/or data network. In some cases, the network is a peer-to-peer network, which may enable devices coupled to the computer system to behave as a client or a server.

In accordance with the description herein, suitable classical computers may include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Smartphones may be suitable for use with methods and systems described herein. Select televisions, video players, and digital music players, in some cases with computer network connectivity, may be suitable for use in the systems and methods described herein. Suitable tablet computers may include those with booklet, slate, and convertible configurations.

In some cases, the classical computer includes an operating system configured to perform executable instructions. The operating system may be, for example, software, including programs and data, which manages the device's hardware and provides services for execution of applications. Suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Suitable personal computer operating systems may include, by way of non-limiting examples, Microsoft® Windows®, Apple® Mac OS X®, Apple® macOS®, UNIX®, and UNIX-like operating systems such as GNU/Linux®. In some cases, the operating system is provided by cloud computing. Suitable mobile smart phone operating systems may include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Suitable media streaming device operating systems may include, by way of non-limiting examples, Apple TV®, Roku®, Boxee®, Google TV®, Google Chromecast®, Amazon Fire®, and Samsung® HomeSync®. Suitable video game console operating systems may include, by way of non-limiting examples, Sony® PS3®, Sony® PS4®, Microsoft® Xbox 360®, Microsoft® Xbox One®, Nintendo® Wii®, Nintendo® Wii U®, and Ouya®.

In some cases, the classical computer includes a storage and/or memory device. In some cases, the storage and/or memory device is one or more physical apparatuses used to store data or programs on a temporary or permanent basis. In some cases, the storage and/or memory device may have one or more additional data storage units that are external to the classical computer, for example, being located on a remote server that is in communication with the classical computer through an intranet or the Internet. In some cases, the device is a volatile memory and requires power to maintain stored information. In some cases, the device is a non-volatile memory and retains stored information when the classical computer is not powered. In some cases, the non-volatile memory comprises flash memory. In some cases, the non-volatile memory comprises dynamic random-access memory (DRAM). In some cases, the non-volatile memory comprises ferroelectric random-access memory (FRAM). In some cases, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In some cases, the storage and/or memory device is a combination of devices such as those disclosed herein.

In some cases, the classical computer includes a display to send visual information to a user. In some cases, the display is a cathode ray tube (CRT). In some cases, the display is a liquid crystal display (LCD). In some cases, the display is a thin film transistor liquid crystal display (TFT-LCD). In some cases, the display is an organic light emitting diode (OLED) display. In some cases, on OLED display is a passive-matrix OLED (PMOLED) or active-matrix OLED (AMOLED) display. In some cases, the display is a plasma display. In other embodiments, the display is a video projector. In some cases, the display is a combination of devices such as those disclosed herein.

In some cases, the classical computer includes an input device to receive information from a user. In some cases, the input device is a keyboard. In some cases, the input device is a pointing device including, by way of non-limiting examples, a mouse, trackball, track pad, joystick, game controller, or stylus. In some cases, the input device is a touch screen or a multi-touch screen. In some cases, the input device is a microphone to capture voice or other sound input. In some cases, the input device is a video camera or other sensor to capture motion or visual input. In some cases, the input device is a Kinect, Leap Motion, or the like. In some cases, the input device is a combination of devices such as those disclosed herein.

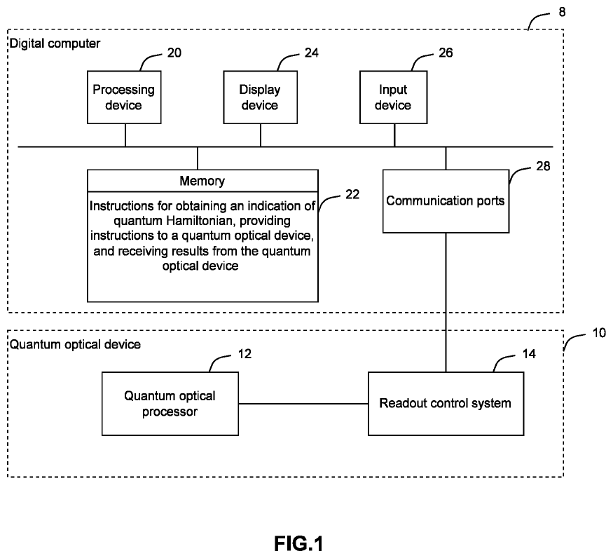

Now referring to FIG. 1, there is shown a schematic of an example of a system for solving an integer or a mixed-integer programming problem using a quantum optical device. The system comprises i) a classical computer 8 which in this embodiment is a digital computer and ii) a quantum optical device 10. The classical computer 8 may be any classical computer disclosed elsewhere herein.

The quantum optical device 10 comprises a quantum optical processor 12 and a control system (e.g., a readout control system) 14. The quantum optical device 10 may be any quantum optical device disclosed elsewhere herein.

The classical computer 8 comprises a processing device 20, a display device 24, an input device 26, communication ports 28, and a memory 22. The processing device 20, the display device 24, the input device 26, the communication ports 28, and the memory 22 may be of various types, such as any type disclosed elsewhere herein. The memory 22 comprises a computer program executable by the processing device 20. The communication ports 28 communicate with the quantum optical device 10 via the readout control system 14.

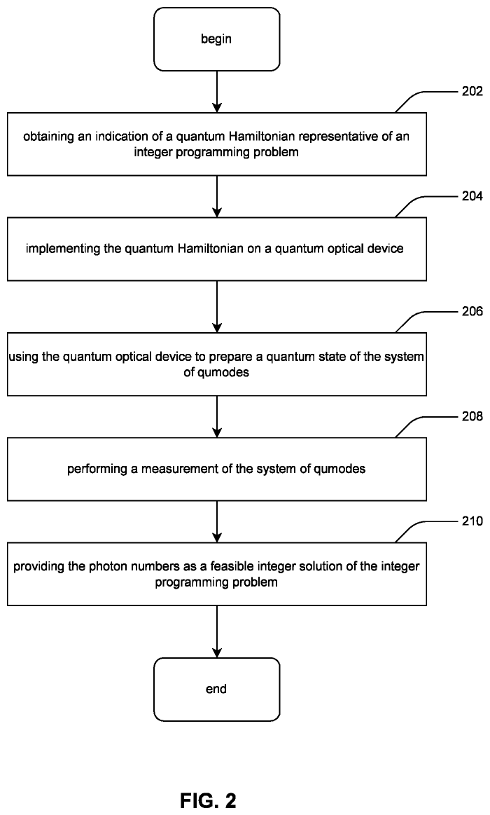

Now referring to FIG. 2, there is shown a flowchart of an example of a method for solving an integer programming problem using a quantum optical device. This example comprises quantum gates, which may correspond to photon-number operators.

According to processing operation 202, an indication of a quantum Hamiltonian representative of an integer programming problem may be obtained. The quantum Hamiltonian may include a class of operators corresponding to variables of the integer programming problem. The class of operators may be photon-number operators of the quantum Hamiltonian. Integer variables of the integer programming problem may correspond to photon-number operators of the quantum Hamiltonian. The indication of the quantum Hamiltonian may be of various types. In some examples, the indication of the quantum Hamiltonian is a mathematical operator representing an energy operator. In some examples, the quantum Hamiltonian may be polynomial (e.g., quadratic) in photon-number operators. The ground states of the quantum Hamiltonian may correspond to the solutions of the integer programming problem.

For example, the target Hamiltonian for solving the maximum-clique problem using the Motzkin-Straus formulation is described in “Maxima for graphs and a new proof of a theorem of Turán” by Motzkin et al., Canadian Journal of Mathematics 17: pp. 533-540, 1965, which is incorporated by reference herein for all purposes. It may be implemented using integer variables and may be given by

$${\hat{H}}_{T} = - {\sum }_{i , j} {A}_{i j} {\hat{n}}_{i} {\hat{n}}_{j} + {W ( {\sum }_{i} {\hat{n}}_{i} - S )}^{2} ,$$

where Aᵢⱼ is the adjacency matrix corresponding to the graph of the problem for which finding the maximum clique may be required. The elements of this matrix are equal to one if there is an edge between the corresponding nodes of the graph and are zero otherwise. The maximum clique of this graph thus corresponds to the largest subgraph of the graph, where all the nodes in this subgraph are connected to each other. The operator \hat{n}ᵢ is the quantum photon-number operator corresponding to the qumode number i and representing the i-th integer variable of the problem, and S is a constant equal to the clique size under consideration and W is a hyperparameter. Since the clique size S is not known, a step-wise search may be performed for the value of S. Starting from smaller values, S may be increased and the process may be repeated until no maximum clique is found. At this step, the found clique may represent the maximum clique with its corresponding value of S being the maximum-clique size. The subscript T in Ĥ_{T} refers to the target Hamiltonian for the algorithm employed. In some examples, the algorithm may be the quantum approximate optimization algorithm (QAOA), the discretized quantum adiabatic algorithm (dQAA), or the actual quantum adiabatic algorithm. The ground states of the target Hamiltonian in the Fock basis |n₁, n₂, . . . , n_{N} [symbol] represent the solution to the integer programming problem defined using Aᵢⱼ, where N is the number of variables (i.e., the number of qumodes). The first term in the target Hamiltonian is the cost function that may be minimized to find a clique, while the second term implements the constraints for maximum-clique solutions introduced in the Motzkin-Straus formulation. The second term enforces the condition term by penalizing the target Hamiltonian. The constant W determines how strongly the constraint is enforced and may be found empirically for each problem.

The indication of the quantum Hamiltonian may be obtained according to various examples.

In some examples, the indication of the quantum Hamiltonian may be obtained using a digital computer. The digital computer may be of various types, such as any digital computer disclosed elsewhere herein. In some examples, the digital computer may be the digital computer 8 disclosed herein with respect to FIG. 1. The indication of the quantum Hamiltonian may be stored in a storage (not shown) or a memory disclosed herein. In some examples, the memory device may be the memory 22 of the digital computer 8.

In some examples, the indication of the quantum Hamiltonian may be provided by a user interacting with the digital computer 8.

In some examples, the indication of the quantum Hamiltonian may be obtained from a remote processing unit, not shown, operatively coupled with the digital computer 8. The remote processing unit may be operatively coupled with the digital computer 8 according to various embodiments. In some examples, the remote processing unit may be coupled with the digital computer 8 via a network disclosed elsewhere herein. In some cases, the network may be a data network. The data network may be selected from a group consisting of a local area network (LAN), a metropolitan area network (MAN), and a wide area network (WAN). In one example, the data network comprises the Internet.

In some examples, the indication of the quantum Hamiltonian may be obtained from a computer-implemented method for solving an integer programming problem.

Still referring to FIG. 2 and according to processing operation 204, the quantum Hamiltonian is implemented on a quantum optical device. The quantum optical device may comprise a system of qumodes and at least one quantum gate configured to act on the qumodes. The operators in the class of operators may correspond to the qumodes in the system of qumodes. The quantum Hamiltonian's photon-number operators may correspond to the quantum optical device's qumodes. The quantum optical device may be of various types, such as any quantum optical device disclosed elsewhere herein. In some examples, the quantum optical device may be the quantum optical device 10 disclosed herein with respect to FIG. 1. Implementing the quantum Hamiltonian on the quantum optical device may involve configuring the quantum optical device. In some examples, the configuring may comprise setting at least one member of the group consisting of: a rotation gate, a Kerr gate, a cross-Kerr gate, a P-gate, a quadratic phase gate, a displacement gate, a displacement momentum gate, a displacement position gate, a Fourier gate, a beam splitter, a squeezing gate, a controlled addition gate, a controlled phase gate, and a two-mode squeezing gate. The quantum gates may be implemented using Kerr nonlinearity (see, for example, “Simple Quantum Computer” by Chuang, Isaac L., and Yoshihisa Yamamoto, Physical Review A 52.5 (1995): 3489), quantum dots (see, for example, “Controlled Phase Shifts with a Single Quantum Dot” by Fushman, Ilya, et al. Science 320.5877 (2008): 769-772), Rydberg blockades (see, for example, “A Photon—Photon Quantum Gate Based on Rydberg Interactions” by Tiarks, Daniel, et al., Nature Physics 15.2 (2019): 124-126.), or four-wave mixing using atomic systems (see, for example, “Conditional π-phase Shift of Single-Photon-Level Pulses at Room Temperature” by Sagona-Stophel, Steven, et al., Physical Review Letters 125.24 (2020): 243601), each of which is incorporated herein by reference in its entirety.

For instance, the target Hamiltonian defined in the description of processing operation 202 may be implemented using a combination of Kerr, cross-Kerr, and rotation gates with corresponding parameters. These gates may be modelled by transforming the quantum states of the qumodes according to the unitary transformations
K(κ)=exp(iκ \hat{n}²), CK(κ)=exp(iκ \hat{n}₁ \hat{n}₂), and R(θ)=exp(iθ \hat{n}),
   respectively. Here, the parameters κ and θ may be determined by the quantum approximate optimization algorithm (QAOA) or the discretized quantum adiabatic algorithm (dQAA), along with the parameters of the target Hamiltonian defined in the description of processing step 202. The Kerr gate K(κ) and the rotation gate R(θ) are single qumode gates, and the cross-Kerr gate CK(κ) is a two-qumode gate. Two-qumode gates may be functions of the photon-number operators \hat{n}₁ and \hat{n}₂ corresponding to the two qumodes on which they act. While the actions of Kerr and cross-Kerr gates may be created experimentally using third-order nonlinearity (i.e., using the Kerr effect), quantum dots, or Rydberg blockades, the action of a rotation gate may be implemented using voltage-controlled optical phase shifters. The constant term WS² in the expanded form of the second term in the target Hamiltonian defined in the description of processing step 202 adds a constant overall phase to the quantum states of the qumodes but has no physical effect on the quantum states of the qumodes. An arbitrary Hamiltonian polynomial (e.g., one that is quadratic) in photon-number operators may be implemented using a combination of Kerr, cross-Kerr, and rotation gates.

According to processing operation 206, the quantum optical device may be used to prepare a quantum state of the system of qumodes, such that the prepared state overlaps (e.g., overlaps at least 80%) with at least one of the ground states of the quantum Hamiltonian. In some cases, the overlap may be with two or more ground states. In some cases, the overlap may be with three or more ground states. In some examples, preparing the quantum state of the system of qumodes may comprise simulating the Hamiltonian of a quantum evolution. In some examples, preparing the quantum state of the system of qumodes may comprise performing a quantum evolution such as an approximation of a quantum adiabatic evolution from a ground state of a mixing Hamiltonian to the quantum state of the system of qumodes. In some examples, the mixing Hamiltonian may comprise quantum operators which do not commute with photon-number operators. In some examples, evolution of the quantum optical device may be performed using the discretized quantum adiabatic algorithm (dQAA). This procedure may be implemented by evolving the quantum states, alternating between using a mixing Hamiltonian and a target Hamiltonian (e.g., such as in the description of processing step 202) for evolution durations according to the scheduling parameters γⱼ and ηⱼ, respectively. This evolution may be repeated P times (where P is the total number of layers in the discretized quantum adiabatic algorithm (dQAA) or the quantum approximate optimization algorithm (QAOA)) until a final quantum state

$$\vert {ψ}_{P} ( η , γ ) 〉 = {\prod }_{j = 1}^{P} {e}^{- i {γ}_{j} {\hat{H}}_{M}} {e}^{- i {η}_{j} {\hat{H}}_{T}} \vert {ψ}_{0} 〉$$

is reached. Here, η=(η₁, η₂, . . . , η_{P}) and γ=(γ₁, γ₂, . . . , γ_{P}). In some examples, the mixing Hamiltonian Ĥ_{M} can be a Hamiltonian that does not commute with the target Hamiltonian. According to the quantum adiabatic theorem, starting from a ground state of the mixing Hamiltonian, the system may arrive at a ground state of the target Hamiltonian. In some examples, the system may arrive at a ground state with appropriate scheduling parameters ηⱼ and γⱼ and after the system has been evolved for P iterations. The scheduling parameters ηⱼ and γⱼ may be chosen such that η₁=0 and γ₁=1, while η_{P}=1 and γ_{P}=0. It can be shown that for a large value of P, the results obtained using the discretized quantum adiabatic algorithm (dQAA) may approach the results obtained using the actual quantum adiabatic algorithm. In some examples, P may be about 100, about 500, or about 1000. For the target Hamiltonian presented in the description of processing operation 202, the mixing Hamiltonian may be given by

$${\hat{H}}_{M} = {\sum }_{i = 1}^{N} {\hat{p}}_{i}^{2} - 2 {p}_{o} {\hat{p}}_{i} .$$

Herein, the operators \hat{p}ᵢ are the momentum operators for the qumodes of the system, defined as

$${\hat{p}}_{i} = \sqrt{\frac{ℏ}{2}} ( {\hat{a}}_{i} - {\hat{a}}_{i}^{†} ) ,$$

where âᵢ are the photon annihilation operators and â†ᵢ are their

Hermitian conjugates that correspond to the creation of a photon (see, for example, Quantum Mechanics by Schwabl, Springer Science & Business Media, 2007, which is incorporated by reference herein for all purposes). The mixing Hamiltonian does not commute with the target Hamiltonian presented in the description of processing operation 202. The eigenstates of this mixing Hamiltonian may be squeezed coherent states centered at

$$α = \frac{{p}_{0}}{\sqrt{2 ℏ}}$$

along the momentum axis and may be squeezed to an amount approaching r=−∞. Since squeezing to an infinite extent is not physically possible, a state with a finite amount of negative squeezing r=−0.5 may be prepared. Although this state may not be the ground state of the mixing Hamiltonian, it may be used for the discretized quantum adiabatic algorithm (dQAA) described herein. This mixing Hamiltonian may be implemented on a quantum optical device using a polynomial phase gate (e.g., a quadratic phase gate

$$P ( α ) = exp ( \frac{i α}{2 ℏ} {\hat{x}}^{2} ) ) .$$

In some examples, this device may also include a position displacement gate

$$X ( x ) = exp ( - \frac{i x}{ℏ} \hat{p} )$$

and Fourier gates (e.g., two Fourier gates). In some examples, the Fourier gates may be rotation gates with rotation angles of 90 degrees and −90 degrees, written as \hat{F}=

$$R ( \frac{π}{2} ) and {\hat{F}}^{†} = R ( - \frac{π}{2} ) ,$$

respectively. Herein, \hat{p} is the momentum operator defined above, while

$$\hat{x} = \sqrt{\frac{ℏ}{2}} ( {\hat{a}}_{i} - {\hat{a}}_{i}^{†} ) ,$$

is the position operator.

In some examples, evolution of the quantum optical device may be performed using the quantum approximate optimization algorithm (QAOA). This procedure is similar to the discretized quantum adiabatic algorithm (dQAA) procedure described herein, but where a classical optimization protocol may be used to find the values ηⱼ and γⱼ. In some cases, certain values of ηⱼ and γⱼ may result in an optimized solution. In some examples, the quantum approximate optimization algorithm (QAOA) may be deployed for a smaller value of P compared to other methods, such as the discretized quantum adiabatic algorithm (dQAA), since running the quantum approximate optimization algorithm (QAOA) for a large value of P may be difficult. Reducing the value of P may shrink the parameter space of the optimization defined by the vectors η=(η₁, η₂, . . . , η_{P}) and γ=(γ₁, γ₂, . . . , γ_{P}). The quantum approximate optimization algorithm (QAOA) with a smaller value of P may be used for devices where having a large number of layers is not physically possible.

In some examples, evolution of the quantum optical device may be performed using gate operations. The quantum optical device may be evolved P times. In some cases, the quantum optical device may be evolved by feeding the output state back into the same quantum optical device as input and adjusting the parameters of the gates. In some cases, the output state may be evolved by feeding it into another device with a different set of parameters. The input parameters for the corresponding gates of each layer of the quantum approximate optimization algorithm (QAOA) corresponding to each quantum optical device may be determined by the scheduling parameters ηⱼ and γⱼ. In some cases, other coefficients related to the mixing and target Hamiltonians may also be used. For instance, for the problem defined in the description of processing step 202, the input values for the gates K(κ), CK(κ), R(θ), P(α), and X(x) of each layer j of the quantum optical device may be determined by the values of ηⱼ, γⱼ, W, p₀, S, and the adjacency matrix A. The output states are obtained after the evolution of the final layer P of the quantum optical device. A measurement may be performed on the quantum optical device to infer the quantum state of the output state for a single run of the procedure, as described herein. The process of measuring a single run of the procedure may be repeated to achieve a probability distribution from which the states with the highest probabilities may be inferred. The number of times this process may be repeated may depend on the required accuracy of the probabilities. In some examples, repeating this process 1000 times may give the probabilities of the output quantum states within an accuracy of 0.001. The states with the highest probabilities may represent the solutions to the problem. The repetition of the process may also be performed by multiple quantum optical devices. In some examples, these repetitions may be performed in parallel by multiple quantum optical devices. In some examples, these devices may be identically programmed quantum optical devices. In some examples, two or more devices may be used to perform these repetitions. In some examples, three or more devices may be used to perform these repetitions.

Still referring to FIG. 2 and according to processing operation 208, a measurement of the system of qumodes may be performed. The measurement may be a quantum measurement of the photon numbers corresponding to the photon-number operators. In some examples, the quantum measurement comprises photon-number-resolving measurement of the qumodes. The photon-number-resolving measurement may be performed by sending the output qumodes to photon detectors. In some examples, these detectors are photon-number-resolving detectors (PNRD). These detectors can determine the number of photons that may be present in each qumode at a certain instance. These detectors may output a series of integers corresponding to the number of photons in each qumode.

Still referring to FIG. 2 and according to processing operation 210, the photon numbers may be provided as an integer solution of the integer programming problem. By generating a histogram of these numbers over one or more runs of the experiment, the probability distribution of the quantum states in the photon-number basis may be inferred. The quantum states with the highest probability and in the photon-number basis defined as |ψₒᵤₜ [symbol] =|n₁, n₂, . . . , n_{N} [symbol] may correspond to the solution of the integer programming problem. The values n₁, n₂, . . . , n_{N} of these quantum states may represent an integer solution of the integer programming problem. In some examples, as in the case of the Motzkin-Straus Hamiltonian presented in processing operation 202, the solution to the maximum-clique problem may be a sequence of integers, where nᵢ=1 if the corresponding graph node belongs to the maximum clique and nᵢ=0 otherwise, identifying the nodes that may participate in the maximum clique of the graph. In this example, the total number of photons may be equal to the maximum-clique size.

The processing operations 206, 208, and 210 may be repeated one or more times, which may improve the quality of the solution. In some examples, due to the potential inaccuracy of the photon-number-resolving detectors (PNRD) in outputting the actual photon number in each qumode, increasing the number of repetitions may help to determine more accurate probability distributions for the output quantum states. The number of repetitions may depend on the accuracy needed to achieve the final probability distribution for a given problem. In some examples, a larger number of repetitions may be performed for a larger problem size, since the accuracy of the probability may drop with growing problem size. This number of repetitions for a given problem may be determined empirically for each problem type and problem size.

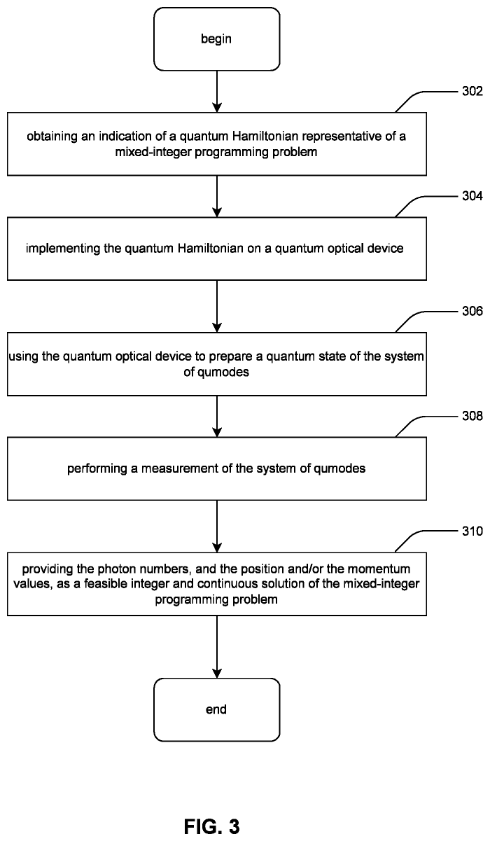

Now referring to FIG. 3, there is shown a flowchart of an example of a method for solving a mixed-integer programming problem using a quantum optical device.

According to processing operation 302, an indication of a quantum Hamiltonian representative of a mixed-integer programming problem is obtained. The mixed-integer programming problem comprises integer and continuous variables. The quantum Hamiltonian may include a class of operators corresponding to the variables. The class of operators may be photon-number operators of the quantum Hamiltonian and momentum and position operators of the quantum Hamiltonian. Integer variables of the integer programming problem correspond to photon-number operators of the quantum Hamiltonian, and continuous variables of the mixed-integer programming problem correspond to momentum or position operators of the quantum Hamiltonian. The indication of the quantum Hamiltonian may be of various types. In some examples, the indication of the quantum Hamiltonian is a mathematical operator representing the energy operator. In one or more embodiments, the quantum Hamiltonian may be quadratic in photon-number operators. In some examples, the quantum Hamiltonian may be quartic in momentum or position operators.

An example of a mixed-integer programming problem is the sparse optimization problem, where the goal is to solve an optimization problem subject to the constraint that at most a certain number of entries of the solution are nonzero. An example of an N-variable sparse optimization problem is:

$$minimize F ( x ) = {\sum }_{i = 1}^{N} {( {x}_{i} - {μ}_{i} )}^{2}$$

$$subject to {\sum }_{i = 1}^{N} {x}_{i} \cdot = S , {\sum }_{i = 1}^{N} {n}_{i} \cdot = B , {x}_{i} \geq 0 for all i .$$

Herein, nᵢ=1 if xᵢ is nonzero and nᵢ=0 if xᵢ=0. The constant B is the number of nonzero variables and should satisfy the condition B<N to make the optimization problem underdetermined. The constants μᵢ represent the minimum of the objective function (not including the constraints). The first constraint is a simplex condition expressing that the sum of the nonzero variables should be equal to S. To solve this problem, N qumodes are defined to represent the continuous variables xᵢ and an additional N qumodes are defined to represent the integer variables nᵢ. The target Hamiltonian for the sparse optimization problem may be defined as

$${\hat{H}}_{T} = {\sum }_{i = 1}^{N} {( {\hat{x}}_{i}^{2} {\hat{n}}_{i + N} - {μ}_{i} )}^{2} + {{λ}_{1} ( {\sum }_{i = 1}^{N} {\hat{x}}_{i}^{2} {\hat{n}}_{i + N} - S )}^{2} + {{λ}_{2} ( {\sum }_{i = 1}^{N} {\hat{n}}_{i + N} - B )}^{2} + {λ}_{3} {\sum }_{i = 1}^{N} ( {\hat{n}}_{i + N} - 1 )$$

The first term implements the objective function f(x), the second term implements the first condition, the third term implements the second condition, and the last term implements the condition that nᵢ can only be zero or one. A total of 2N qumodes are needed to solve this problem. The first N qumodes' quantum operators \hat{x}ᵢ² represent the continuous variables xᵢ, and are squared to satisfy the positivity condition for the variables xᵢ. The second N qumodes' quantum operators \hat{n}_{i+N} represent the integer variables nᵢ. The parameters λ₁, λ₂, and λ₃ are hyperparameters that may be tuned to improve the performance of the algorithm. Each term of the target Hamiltonian may enforce the corresponding condition or objective function by penalizing the target Hamiltonian for nonzero values. Since the eigenvalues of \hat{n}_{i+N} can only be 0 or 1, substituting the variables xᵢ with the quantum operators \hat{x}ᵢ²\hat{n}_{i+N} may guarantee that only the eigenvalues of \hat{x}ᵢ² that have their corresponding eigenvalue of \hat{n}_{i+N} be nonzero contribute to the target Hamiltonian. The mixing Hamiltonian used for the actual quantum adiabatic algorithm, the discretized quantum adiabatic algorithm (dQAA), and the quantum approximate optimization algorithm (QAOA) may be the same as the one used for the integer programming problem described with respect to FIG. 2, in processing operation 202. Since this mixing Hamiltonian is written in terms of the momentum operators, it does not commute with the mentioned target Hamiltonian and thus it satisfies the non-commutability condition of the quantum adiabatic theorem.

The indication of the quantum Hamiltonian may be obtained according to various examples.

In some examples, the indication of the quantum Hamiltonian may be obtained using a digital computer. The digital computer may be of various types, such as any digital computer disclosed herein. In some examples, the digital computer may be the digital computer 8 disclosed herein with respect to FIG. 1. The indication of the quantum Hamiltonian may be stored in a storage and/or memory device disclosed herein. In some examples, the memory device may be the memory 22 of the digital computer 8.

In some examples, the indication of the quantum Hamiltonian may be provided by a user interacting with the digital computer 8.

In some examples, the indication of the quantum Hamiltonian may be obtained from a remote processing unit, not shown, operatively coupled with the digital computer 8. The remote processing unit may be operatively coupled with the digital computer 8 according to various embodiments. In some examples, the remote processing unit may be coupled with the digital computer 8 via a network disclosed herein. In some cases, the network may be a data network. The data network may be selected from a group consisting of a local area network (LAN), a metropolitan area network (MAN), and a wide area network (WAN). In one example, the data network comprises the Internet.

In some examples, the indication of the quantum Hamiltonian may be obtained from a computer-implemented method for solving a mixed-integer programming problem.

Still referring to FIG. 3 and according to processing operation 304, the quantum Hamiltonian may be implemented on a quantum optical device. The quantum optical device may comprise a system of qumodes and at least one quantum gate configured to act on the qumodes. The class of operators may correspond to the system of qumodes. The quantum Hamiltonian's photon number, position, and momentum operators may correspond to the quantum optical device's qumodes.

The quantum optical device may be of various types, such as any quantum optical device disclosed herein. In some examples, the quantum optical device may be the quantum optical device 10 disclosed herein with respect to FIG. 1. Implementing the quantum Hamiltonian on the quantum optical device may involve configuring the quantum optical device. In some examples, the configuring may comprise setting at least one member of the group consisting of: a rotation gate, a Kerr gate, a cross-Kerr gate, a P-gate, a quadratic phase gate, a displacement gate, a displacement momentum gate, a displacement position gate, a Fourier gate, a beam splitter, a squeezing gate, a controlled addition gate, a controlled phase gate, a two-mode squeezing gate, a position-rotation gate, a quadratic position-rotation gate, a cross-position-rotation gate, a momentum-rotation gate, a quadratic momentum-rotation gate, and a cross-momentum-rotation gate. Some of the quantum gates may be implemented using Kerr nonlinearity, quantum dots, Rydberg blockades, or four-wave mixing atomic systems. The quantum Hamiltonian in processing operation 302 may be implemented by a combination of the position-rotation gate XN(α, m)=exp(iα\hat{x}ᵢ^{m}\hat{n}ⱼ), the quadratic position- rotation gate XN2(α, m)=exp(iα\hat{x}ᵢ^{2m}\hat{n}ⱼ²), the cross-position-rotation gate CXN(α, m) =exp(iα\hat{x}ᵢ^{m}\hat{n}ⱼ\hat{x}ₖ^{m}\hat{n}ₗ), the rotation gate, the Kerr gate, and the cross-Kerr gate, with m=2. Since all the terms in the quantum Hamiltonian of processing operation 302 commute with each other, these gates may be implemented with their corresponding parameters in no particular order. For other mixed-integer programming problems, other quantum gates may be defined depending on the combination of continuous and integer variables present in a particular problem.

Some of the quantum gates disclosed elsewhere herein, such as the position-rotation, quadratic position-rotation, momentum-rotation, quadratic momentum-rotation, cross-position-rotation, and cross-momentum-rotation gates, may be required for implementing methods disclosed elsewhere herein for solving mixed-integer programming problems on the quantum optical device. Gates such as the position-rotation gate XN(α, m)=exp(iα\hat{x}ᵢ^{m}\hat{n}ⱼ), with m=1, require the same order of optical nonlinearity as the cubic phase gate C(γ)=exp(iγ\hat{x}³) and thus similar approaches may be used for creating such quantum interactions (see, for example, “Engineering a Kerr-based Deterministic Cubic Phase Gate via Gaussian Operations” by Yanagimoto et al., Physical Review Letters 124, no. 24:240503, 2020, which is incorporated by reference herein for all purposes). In combination with gate decomposition techniques, the mentioned gates may be reduced to lower-order known gates such as the cubic phase gate, quadratic phase gate, Kerr gate, or cross-Kerr gate and may be implemented approximately. By repeatedly applying lower-order gates such as the Kerr gate, quadratic phase gate, or squeezing gate, decomposition techniques may allow the approximate implementation of higher-order gates (see, for example, “How to Decompose Arbitrary Continuous-Variable Quantum Operations” by Sefi et al., Physical Review Letters 107, no. 17: 170501, 2011, which is incorporated by reference herein for all purposes). The quantum gates that perform a combined unitary operation of the quadrature operations and the photon-number operator are fundamental features of this invention, which may improve the solving of mixed-integer programming problems using a quantum optical device.

The methods and systems disclosed herein take advantage of the internal functioning of the quantum optical device to solve integer or mixed-integer programming problems. This internal functioning refers to the quantum optical device being fundamentally a bosonic system that is represented by an infinite-dimensional Hilbert space that has photon-number states as the basis. Being a bosonic system, the photons in the quantum optical device follow Bose-Einstein statistics, meaning that multiple photons may be present simultaneously in the same quantum state. The bosonic nature of the quantum optical device, as described elsewhere herein, may be expressed by writing the quantum states as the superposition of all possible photon-number states, up to infinity. Since photon numbers are fundamentally non-negative integers, the integer variables of the problem may be represented by the photon-number operators of the corresponding qumodes. Having only integer eigenvalues, the photon-number operators may represent integer variables of the problem without the need for ancilla qumodes. The fundamental feature of the quantum optical device that the photon-number states are discrete allows the representation of integer variables of a problem using the internal functioning of the quantum optical device. This approach may make efficient use of the resources available in a quantum optical device which may reduce the overhead. Combining this with the usual approach of representing continuous variables using quadrature operators, the quantum optical device may be capable of efficiently solving integer or mixed-integer programming problems.

According to processing operation 306, the quantum optical device may be used to prepare a quantum state of the system of qumodes, such that the prepared state has an overlap (e.g., an overlap of at least 80%) with at least one of the ground states of the quantum Hamiltonian. In some cases, the overlap may be with two or more ground states. In some cases, the overlap may be with three or more ground states. In some examples, preparing the quantum state of the system of qumodes may comprise simulating the Hamiltonian of a quantum evolution. In some examples, preparing the quantum state of the system of qumodes may comprise performing a quantum evolution such as an approximation of a quantum adiabatic evolution from a ground state of a mixing Hamiltonian to the quantum state of the system of qumodes. In some examples, the mixing Hamiltonian may comprise quantum operators which do not commute with photon-number operators. In some examples, the mixing Hamiltonian may comprise position or momentum operators as the operators that do not commute with photon-number operators.

In some examples, evolution of the quantum optical device may be performed using the discretized quantum adiabatic algorithm (dQAA). This procedure may be implemented by evolving the quantum states, alternating between using a mixing Hamiltonian and a target Hamiltonian (e.g., such as in the description of processing step 302) for evolution durations according to the scheduling parameters γⱼ and ηⱼ, respectively. This evolution may be repeated P times until a final quantum state

$$\vert {ψ}_{P} ( η , γ ) 〉 = {\prod }_{j = 1}^{P} {e}^{- i {γ}_{j} {\hat{H}}_{M}} {e}^{- i {η}_{j} {\hat{H}}_{T}} \vert {ψ}_{0} 〉$$

is reached. Here, η=(η₁, η₂, . . . , η_{P}) and γ=(γ₁, γ₂, . . . , γ_{P}). In some examples, the mixing Hamiltonian Ĥ_{M} can be a Hamiltonian that does not commute with the target Hamiltonian. According to the quantum adiabatic evolution theorem, starting from a ground state of the mixing Hamiltonian, the system may arrive at a ground state of the target Hamiltonian. In some examples, the system may arrive at a ground state with appropriate scheduling parameters ηⱼ and γⱼ, and after the system has been evolved for P iterations. The scheduling parameters ηⱼ and γⱼ may be chosen such that η₁=0 and γ₁=1, while η_{P}=1 and γ_{P}=0. It can be shown that for a large value of P, the results obtained using the discretized quantum adiabatic algorithm (dQAA) may approach the results obtained using the actual quantum adiabatic algorithm. In some examples, P may be about 100, about 500, or about 1000. For the target Hamiltonian presented in the description of processing operation 302, the mixing Hamiltonian may be given by

$${\hat{H}}_{M} = {\sum }_{i = I}^{N} {\hat{p}}_{i}^{2} - 2 {p}_{0} {\hat{p}}_{i} .$$

This mixing Hamiltonian does not commute with the target Hamiltonian presented in the description of processing operation 302. The eigenstates of this mixing Hamiltonian may be squeezed coherent states centered at

$$α = \frac{{p}_{0}}{\sqrt{2 ℏ}}$$

along the momentum axis and may be squeezed to an amount approaching r=−∞. Since squeezing to an infinite extent is not physically possible, a state with a finite amount of negative squeezing r=−0.5 may be prepared. Although this state may not be the ground state of the mixing Hamiltonian, it may be used for the discretized quantum adiabatic algorithm (dQAA) described herein. This mixing Hamiltonian may be implemented on a quantum optical device using a polynomial phase gate (e.g., a quadratic phase gate

$$P ( α ) = exp ( \frac{i α}{2 ℏ} {\hat{x}}^{2} ) ) .$$

In some examples, this device may also include a position displacement gate

$$X ( x ) = exp ( - \frac{i x}{ℏ} \hat{p} )$$

and Fourier gates (e.g., two Fourier gates). In some examples, the Fourier gates may be rotation gates with rotation angles of 90 degrees and −90 degrees, written as

$$\hat{F} = R ( \frac{π}{2} ) {\hat{F}}^{†} and \hat{{F}^{†}} = R ( - \frac{π}{2} ) ,$$

respectively.

In some examples, evolution of the quantum optical device may be performed using the quantum approximate optimization algorithm (QAOA). This procedure is similar to the discretized quantum adiabatic algorithm (dQAA) described herein, but where a classical optimization protocol may be used to find the values ηⱼ and γⱼ. In some cases, certain values of ηⱼ and γⱼ may result in an optimized solution. In some examples, the quantum approximate optimization algorithm (QAOA) may be deployed for a smaller value of P compared to other methods, such as the discretized quantum adiabatic algorithm (dQAA), since running the quantum approximate optimization algorithm (QAOA) for a larger value of P may be difficult. Reducing the value of P may shrink the parameter space of the optimization defined by the vectors η=(η₁, η₂, . . . , η_{P}) and γ=(γ₁, γ₂, . . . , γ_{P}). The quantum approximate optimization algorithm (QAOA) with a smaller value of P may be used for devices where having a large number of layers is not physically possible.

In one or more embodiments, evolution of the quantum optical device may be performed using gate operations. The quantum optical device may be evolved P times. In some cases, the quantum optical device may be evolved by feeding the output state back into the same quantum optical device as input and adjusting the parameters of the gates. In some cases, the output state may be evolved by feeding it into another device with a different set of parameters. The input parameters for the corresponding gates of each layer of the quantum approximate optimization algorithm (QAOA) corresponding to each quantum optical device may be determined by the scheduling parameters ηⱼ and γⱼ. In some cases, other coefficients related to the mixing and target Hamiltonians may also be used. For instance, for the problem defined in description of processing step 302, the input values for the gates XN(α, m), XN2(α, m), CXN(α, m), R(θ), K(κ), CK(κ), P(α), and X(x) of each layer j of the optical device may be determined by the variables ηⱼ, γⱼ, λ₁, λ₂, λ₃, p₀, S, μ₁, μ₂, μ₃, and B, with m=2. The output states are obtained after the evolution of the final layer P of the optical device. The measurement may be performed on the optical device to infer the quantum state of the output state for a single run of the procedure, as described herein. The process of measuring a single run of the procedure may be repeated to achieve a probability distribution from which the states with the highest probabilities may be inferred. The number of times the process may be repeated may depend on the accuracy of the probabilities required. In some examples, repeating the process 1000 times may give the probabilities of the output quantum states with an accuracy of 0.001. The states with the highest probabilities may represent the solutions to the problem. The repetition of the process may also be performed by multiple quantum optical devices. In some examples, these repetitions may be performed in parallel by multiple quantum optical devices. In some examples, these devices may be identically programmed quantum optical devices. In some examples, two or more devices may be used to perform these repetitions. In some examples, three or more devices may be used to perform these repetitions.

Still referring to FIG. 3 and according to processing operation 308, a measurement of the system of qumodes may be performed. The measurement may be a quantum measurement of photon numbers corresponding to the photon-number operators. In some examples, the quantum measurement comprises photon-number-resolving measurement of the qumodes. The photon-number-resolving measurement may be performed by sending the output qumodes to photon detectors. In some examples, these detectors are photon-number-resolving detectors (PNRD). These detectors can resolve the number of photons that may be present in each qumode at a certain instance. These detectors may output a series of integers corresponding to the number of photons in each qumode. In some examples, measurement may comprise performing a homodyne measurement corresponding to the position and momentum operators to obtain the position and the momentum values of the qumodes. The homodyne measurement may comprise using a beam splitter and two photo-detectors for measuring two out-of-phase components of the optical electric field. The two measured components of the optical electric field represent the eigenvalues of the position and momentum operators \hat{x} and \hat{p}. When performed on the qumodes that represent the continuous variables of a mixed-integer programming problem, the results of these homodyne measurements may provide the solutions for the continuous variables of the quantum Hamiltonian described in processing operation 302.

Still referring to FIG. 3 and according to processing operation 310, the photon numbers, and the position and/or the momentum values, may be provided as a feasible integer and continuous solution of the mixed-integer programming problem. The photon numbers are provided as values for the integer variables of the mixed-integer programming problem, and the position and the momentum values are provided as values of the continuous variables of the mixed-integer programming problem. For example, in the sparse optimization problem presented in the description of processing operation 302, performing homodyne measurements on the first N qumodes in the position basis may reveal the solution values of the continuous variables xᵢ, while performing photon-number-resolving measurements on the second N qumodes may reveal the solution values of the integer variables nᵢ. The values of nᵢ may be either 0 or 1 with high probability. If, for a given qumode, nᵢ=0, the corresponding value xᵢ should be ignored, and if nᵢ=1, the corresponding value xᵢ may represent the solution to the sparse optimization problem. In other words, the measured values xᵢ may be the solutions to the mixed-integer programming problem only if the corresponding measured photon number value nᵢ is equal to 1.

The processing operations 306, 308, and 310 may be repeated one or more times, which may improve the quality of the solution. In some examples, due to the inaccuracy of the photon-number-resolving detectors (PNRD) in outputting the actual photon number in each qumode, increasing the number of repetitions may help to determine more accurate probability distributions for the output quantum states. For the homodyne measurements of the qumodes representing continuous variables of the mixed-integer programming problem, the solution of the continuous variables may be found by taking the average of the results obtained over repeated homodyne measurements. The greater the number of measurements, the more accurate the averaged values of the continuous variables may be. The number of repetitions for both photon-number-resolving measurements and homodyne measurements may depend on the desired accuracy of the final probability distribution or the desired accuracy of the averaged continuous variables for a given problem. In some examples, a greater number of repetitions may be performed for a larger problem size, since these accuracies may decrease with increasing problem size. This number of repetitions for a given problem may be determined empirically for each problem type and problem size.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for solving an integer programming problem or a mixed-integer programming problem using a quantum optical device, the method comprising:
(a) obtaining an indication of a quantum Hamiltonian representative of said integer programming problem or said mixed-integer programming problem, wherein said quantum Hamiltonian comprises a class of operators corresponding to variables of said integer programming problem or said mixed-integer programming problem;
(b) implementing said quantum Hamiltonian on said quantum optical device, wherein said quantum optical device comprises a system of qumodes and at least one quantum gate configured to act on one or more qumodes in said system of qumodes, and wherein one or more operators in said class of operators corresponds to said one or more qumodes in said system of qumodes; and
(c) providing a solution of said integer programming problem or said mixed-integer programming problem based at least in part on a measurement of said system of qumodes.

2. The method of claim 1, wherein said class of operators comprises one or more of photon-number operators and momentum and position operators of said quantum Hamiltonian.

3. The method of claim 2, wherein integer variables of said integer programming problem or said mixed-integer programming problem correspond to said photon-number operators of said quantum Hamiltonian and wherein continuous variables of said mixed-integer programming problem correspond to said momentum and position operators of said quantum Hamiltonian.

4. The method of claim 1, wherein a quantum state of said system of qumodes overlaps with a ground state of said quantum Hamiltonian.

5. The method of claim 2, wherein said measurement comprises one or more of: (A) a measurement corresponding to said photon-number operators to obtain photon-number values, optionally comprising a photon-number-resolving measurement of said one or more qumodes; (B) a homodyne measurement corresponding to said position and momentum operators to obtain position and momentum values, optionally comprising a homodyne detection using a beam splitter and two photo-detectors for measuring two out-of-phase components of the optical electric field.

6. The method of claim 1, wherein (b) further comprises: (i) using said quantum optical device to prepare a quantum state of said system of qumodes comprising performing one or more gate operations.

7. The method of claim 6, further comprising simulating a Hamiltonian of a quantum adiabatic evolution.

8. The method of claim 6, wherein (i) comprises an approximation of a quantum adiabatic evolution from a ground state of a mixing Hamiltonian to said quantum state of said system of qumodes.

9. The method of claim 8, wherein said mixing Hamiltonian comprises operators which do not commute with photon-number operators.

10. The method of claim 8, wherein said mixing Hamiltonian comprises position or momentum operators as non-commuting operators with photon-number operators.

11. The method of claim 8, wherein said approximation of said quantum adiabatic evolution comprises one or more of: (A) a discretized quantum adiabatic algorithm (dQAA) procedure; (B) a quantum approximate optimization algorithm (QAOA) procedure.

12. The method of claim 1, wherein (c) further comprises: (ii) performing said measurement of said system of qumodes.

13. The method of claim 1, wherein (b) comprises configuring said quantum optical device, wherein said configuring comprises setting one or more of: a rotation gate, a Kerr gate, a cross-Kerr gate, a P-gate, a quadratic phase gate, a displacement gate, a displacement momentum gate, a displacement position gate, a Fourier gate, a beam splitter, a squeezing gate, a controlled addition gate, a controlled phase gate, a two-mode squeezing gate, a position-rotation gate, a quadratic position-rotation gate, a cross-position-rotation gate, a momentum-rotation gate, a quadratic momentum-rotation gate, or a cross-momentum-rotation gate.

14. The method of claim 1, wherein said at least one quantum gate is implemented using at least one of Kerr nonlinearity, quantum dots, Rydberg blockades, or four-wave mixing atomic systems.

15. The method of claim 1, wherein said quantum Hamiltonian is quadratic in photon-number operators and is quartic in momentum and position operators.

16. The method of claim 1, wherein (b) comprises (i) using said quantum optical device to prepare a quantum state of said system of qumodes, and wherein (c) comprises (ii) performing a measurement of said system of qumodes, wherein (i), (ii), and (c) are repeated one or more times.

17. The method of claim 16, wherein (i), (ii), and (c) are repeated one or more times until a convergence condition is met, and, optionally, wherein said convergence condition comprises a threshold number of iterations or a threshold change in an objective function.

18. The method of claim 1, wherein said indication of the quantum Hamiltonian is obtained from a user or from a computer-implemented method for solving said integer programming problem or said mixed-integer programming problem.

19. A quantum optical device comprising a system of qumodes and at least one quantum gate configured to act on one or more qumodes of said system of qumodes, wherein said at least one quantum gate comprises at least one member of the group including a rotation gate, a Kerr gate, a cross-Kerr gate, a P-gate, a quadratic phase gate, a displacement gate, a displacement momentum gate, a displacement position gate, a Fourier gate, a beam splitter, a squeezing gate, a controlled addition gate, a controlled phase gate, a two-mode squeezing gate, a position-rotation gate, a quadratic position-rotation gate, a cross-position-rotation gate, a momentum-rotation gate, a quadratic momentum-rotation gate, or a cross-momentum-rotation gate.

20. The quantum optical device of claim 19 is configured to at least: (i) implement a quantum Hamiltonian; (ii) prepare a quantum state of said system of qumodes; and (iii) perform measurements of said system of qumodes; wherein said quantum optical device is operatively coupled to a digital computer, said digital computer comprising a memory comprising instructions, wherein said digital computer is configured to execute said instructions to at least: (i) obtain an indication of a quantum Hamiltonian representative of an integer programming problem or a mixed-integer programming problem; (ii) provide said instructions to said quantum optical device; and (iii) receive results from said quantum optical device; wherein said quantum optical device further comprises a control system, wherein the control system is configured to receive instructions from said digital computer operably coupled to said quantum optical device.

21. A method for solving an integer programming problem or a mixed-integer programming problem using a quantum optical device, the method comprising at a digital computer operably connected to said quantum optical device:
(a) obtaining an indication of a quantum Hamiltonian representative of said integer programming problem or said mixed-integer programming problem, wherein said quantum Hamiltonian comprises a class of operators corresponding to variables of said integer programming problem or said mixed-integer programming problem;
(b) directing said quantum Hamiltonian to said quantum optical device to implement said quantum Hamiltonian on said optical device, wherein said quantum optical device comprises a system of qumodes and at least one quantum gate configured to act on one or more qumodes in said system of qumodes, and wherein one or more operators in said class of operators corresponds to said one or more qumodes in said system of qumodes; and
(c) providing a solution of said integer programming problem or said mixed-integer programming problem based at least in part on a measurement of said system of qumodes on said quantum optical device.
